(19) United States
(12) Patent Application Publication
(10) Pub. No.: US 2006/0099967 A1
(43) Pub. Date: May 11, 2006

(54) Methods, systems, and computer program products for implementing proximity-based sound emission controls

(76) Inventors: Emily Colvin, Sandy Springs, GA (US); John Slemmer, Norcross, GA (US)

Correspondence Address: CANTOR COLBURN LLP - BELLSOUTH, 55 GRIFFIN ROAD SOUTH, BLOOMFIELD, CT, 06002, US

(21) Appl. No.: 10/986,506

(22) Filed: Nov. 11, 2004

(51) Int. Cl. H04Q 7/20

(52) U.S. Cl. 455/456.4

(57) ABSTRACT

Methods, systems, and computer program products for implementing proximity-based sound emission controls. The method includes detecting the presence of a device at a controlled access location. The detecting is performed upon entrance to the controlled access location by the device. The method also includes adjusting sound control settings established for the device.

### BACKGROUND

Exemplary embodiments relate generally to telecommunications, and more particularly, to methods, systems, and computer program products for implementing proximity-based sound emission controls.

Communication devices, such as cellular telephones (cell phones) have become ubiquitous in every day life. The increasing usage of these devices have contributed to new societal problems in that many find them to be, at times, invasive or disruptive. For example, an outdoor soccer stadium would likely be able to absorb the sound of a ringer (as well as an ensuing conversation) much more readily than would an indoor dining establishment. Another problem caused by these devices is the disruption caused by the ringer sound during certain situations such as a concert hall event, library, or religious service. Additionally, with respect to cell phones, the actual usage may be harmful in certain situations (e.g., during the operation of medical machinery or other equipment that might be adversely affected by cell phone activity). Thus, the sound of a device's ringer (and associated usage) may be acceptable in some situations but offensive, inappropriate, or harmful in others.

Some wireless communications devices offer limited ringer control. For example, a cell phone may be pre-programmed in a time-based manner such that for a designated period of time, it will vibrate upon receipt of each incoming call. The device may also be set to ‘ring’ during another time period. This time-based feature would not address the above-described problems unless the user of the cell phone was able to precisely predict his/her future activities and pre-program the device accordingly. Clearly, this would not be an optimal solution. What is needed, therefore, is a way to control situation-based sound emissions of wireless communication devices.

### SUMMARY

Exemplary embodiments relate to methods, systems, and computer program products for implementing proximity-based sound emission controls of communication devices. Methods include detecting the presence of a device at a controlled access location. The detecting is performed upon entrance to the controlled access location by the device. The method also includes adjusting sound control settings established for the device.

Systems for implementing proximity-based sound emission controls include a communications device and a sound control system in communication with the communications device. The sound control system includes a receiver component for detecting the presence of the communications device at a controlled access location. The detecting is performed upon entrance to the controlled access location by a user of the communications device. The sound control system also includes a transceiver component for communicating with the communications device and an application executing on a processor for adjusting the sound control settings established by the communications device. The adjusting is performed via the transceiver component.

Computer program products include instructions for performing a method. The method includes detecting the presence of a device at a controlled access location. The detecting is performed upon entrance to the controlled access location by the device. The method also includes adjusting sound control settings established for the device.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several FIGURES:

FIG. 1 is a block diagram of a system upon which the sound control functions may be implemented in exemplary embodiments;

FIG. 2 is a flow diagram of a process for implementing sound control activities with authorization according to exemplary embodiments;

FIG. 3 is a flow diagram of a process for implementing sound control activities without authorization according to exemplary embodiments;

FIG. 4 is an exemplary database of controlled access location information in exemplary embodiments; and

FIG. 5 is an exemplary database table of controlled access customer records in exemplary embodiments.

### DETAILED DESCRIPTION OF EXEMPLARY EMBODIMENTS

In accordance with exemplary embodiments, sound control services are provided. The sound control services enable controlled access locations to minimize the occurrence of potentially objectionable sound emissions originating from communication devices that are present at these locations. For example, users of wireless communications devices (e.g., cell phones, pagers, etc.) that frequent a controlled access location may provide explicit or implicit permission for their devices to be manipulated at a point of entry to, and exit from, the controlled access location. The controlled access services include manipulating these devices by sending one or more signals to the devices causing their sound control state or settings to be altered. These alterations include setting a ringer function to vibrate or silent mode (e.g., an LED may flash indicating an incoming call), or a volume-lowering function that sets the device volume to a pre-established level.

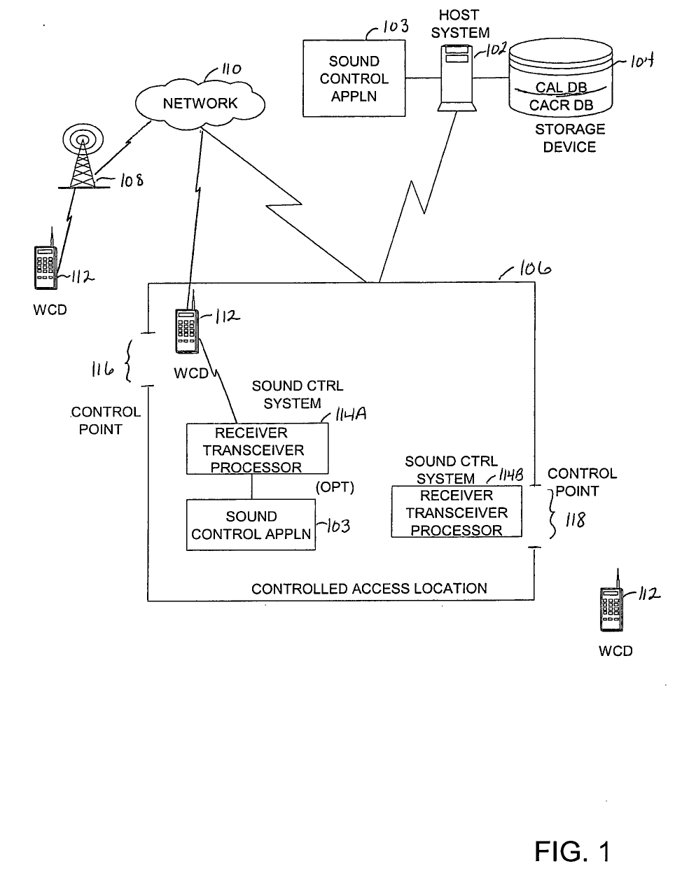

Turning now to FIG. 1, a system upon which the sound control activities may be implemented will now be described. In accordance with exemplary embodiments, the system of FIG. 1 includes a host system 102 and controlled access location 106. Devices within the controlled access location 106 may communicate with the host system 102 via a network 110. Also included in the exemplary system of FIG. 1 are a cell tower 108 and a wireless communication device 112.

In exemplary embodiments, host system 102 is a third-party service provider entity (e.g., an application service provider (ASP) that provides controlled access system services to customers (e.g., carrier systems) for a fee. Alternatively, host system 102 may be a communications services provider that provides carrier services to its customers (e.g., a user of wireless communications device 112). The host system 102 depicted in FIG. 1 may be implemented using one or more servers operating in response to a computer program stored in a storage medium accessible by the server. The host system 102 may operate as a network server (e.g., a web server) to communicate with the controlled access location 106 and/or device 112. The host system 102 may handle sending and receiving information to and from the controlled access location 106 and may perform associated tasks.

The host system 102 may also operate as an application server. The host system 102 executes one or more computer programs to provide sound control functions. These one or more computer programs are referred to collectively herein as a sound control system application 103. Processing of sound control activities may be shared by devices within the controlled access location 106 and the host system 102 by providing an application (e.g., java applet) to devices within the controlled access location 106. Alternatively, a stand-alone software application at the controlled access location 106 may perform a portion or all of the processing described herein. As previously described, it is understood that separate servers may be utilized to implement the network server functions and the application server functions. Alternatively, the network server and the application server may be implemented by a single server executing computer programs to perform the requisite functions.

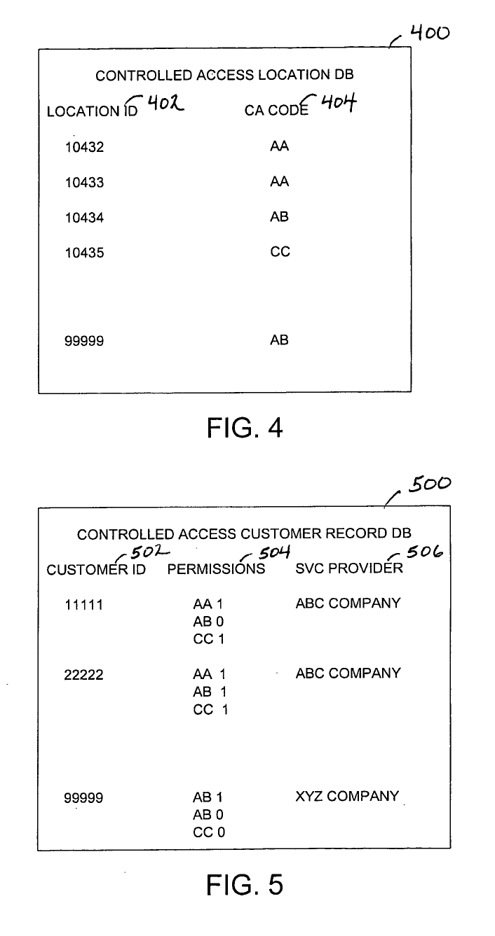

In exemplary embodiments, the system shown in FIG. 1 includes a storage device 104. Storage device 104 is in communication with host system 102 and may be implemented using a variety of devices for storing electronic information. It is understood that the storage device 104 may be implemented using memory contained in the host system 102 or it may be a separate physical device. The storage device 104 is logically addressable as a consolidated data source across a distributed environment that includes network 110. Information stored in the storage device 104 may be retrieved and manipulated via the host system 102. The storage device 104 houses one or more databases of customer access location information and controlled access customer records. Sample database information is shown and described in FIGS. 4 and 5. In an exemplary embodiment, the host system 102 operates as a database server and coordinates access to application data including data stored on storage device 104

Network 110 may be any type of known network including, but not limited to, a wide area network (WAN), a local area network (LAN), a global network (e.g. Internet), a virtual private network (VPN), and an intranet. The network 110 may be implemented using a wireless network or any kind of physical network implementation known in the art. Devices within the controlled access location 106 may be coupled to the host system 102 through multiple networks (e.g., intranet and Internet) so that not all controlled access locations are coupled to the host system 102 through the same network. Devices within one or more of the controlled access locations and the host system 102 may be connected to the network 110 in a wireless fashion. In one embodiment, the network 110 is an intranet, and one or more devices in one or more controlled access locations 106 execute a user interface application (e.g. a web browser) to contact the host system 102 through the network 110 while a device in another controlled access location 106 is directly connected to the host system 102.

Cell tower 108 refers to a cellular network element that receives and transmits wireless communications between communications devices within a cell location or between a wireless communication device (e.g., wireless communication device 112) and a carrier system or central office (e.g., host system 102 where host system 102 is a carrier). Wireless communication device 112 refers to a mobile communications device that communicates with other communication devices over a network. Wireless communications device 112 may be, for example, a pager, a cellular telephone, a personal digital assistant, or any similar type of handheld device that produces a noise. For purposes of illustration, the wireless communications device 112 will be described herein with respect to a cell phone.

Controlled access location 106 refers to a site that is at least partially enclosed and in which one or more controlled entrances/exits are provided. Controlled access location 106 may be a movie theatre, restaurant, hospital, library, church, or other entity that desires to provide sound control activities as described herein. Controlled access location 106 includes control points 116 and 118. For purposes of illustration, control points 116 and 118 each provide both ingress and egress to controlled access location 106. However, it will be understood that one of control points 116 and 118 may be designated as an entranceway and the other an exit way.

In exemplary embodiments, sound control systems 114A-B are also included in controlled access location 106. Sound control systems 114A-B are located at each point of entry and exit associated with controlled access system 106. Sound control systems 114A-B each includes receiver, transceiver, and processor components. The receiver component senses or detects the presence of any wireless communications devices.

The transceiver component communicates with one or both of the wireless communication device 112 and the host system 102 as will be described further herein. The transceiver component performs functions similar to that of a cell tower and utilizes similar technology that enables it to detect the presence of a cell phone or other wireless device. Unlike the cell tower, however, it may be enabled with a mechanism for listening to all common mobile device technologies (e.g., CDMA, TDMA, GSM, analog, digital, etc.), as well as licensed frequencies so that it becomes vendor neutral. Further, the transceiver component may be equipped with reduced sensitivity and power as compared to a traditional cell tower, as it handles communications within a smaller geography or space. It may also be focused and calibrated in accordance with the size and shape of the point of entry or control points (e.g., 116, 118).

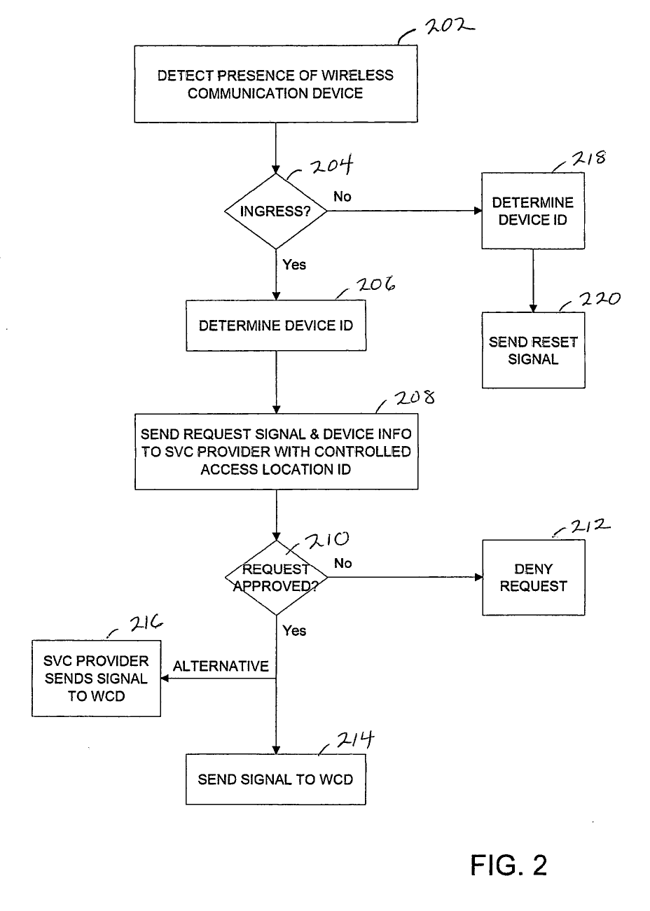

The processor contains logic for handling the generation and transmission of requests for authorization to change the state of wireless communication device 112 (e.g., adjust the sound control setting) and may, alternatively, handle the actual implementation of the adjustments directly with the wireless communication device 112. Authorization requirements relating to the sound control activities are addressed in the flow diagram of FIG. 2.

There may exist situations in which authorization is required prior to changing the state of a wireless communication device. The authorization requirements, for example, may stem from laws designed to protect safety (e.g., in critical care units where operation of a communication device may be harmful, on an airplane where the operation may interfere with flight operations, etc.). Alternatively, the authorizations may stem from the explicit permissions granted by users of wireless communications devices through their respective service providers (or via selected menu options located directly on the wireless device). Additionally, authorization may be implicit (e.g., information posted at the entrance of a controlled access location that notifies visitors that their patronage signifies an implicit consent to have their devices' state altered).

Turning now to FIG. 2, a flow diagram of a process for implementing the sound control activities with authorization will now be described. A user with a wireless communications device 112 approaches a controlled access location 106. The user then passes through control point 116 and the receiver component of the sound control system 114A (or 114B) detects its presence at step 202. As the control points are bi-directional (e.g., persons may both enter and exit via either of the control points), it is determined whether the presence of the wireless communication device 112 is related to an ingress or egress at step 204. If the movement is ingress (i.e., the user is entering the controlled access location 106), the sound control system application 103 identifies the wireless communication device 112 at step 206. The sound control system 114A or 114B then sends a request to host system 102 to change the state of the wireless communication device 112 via the transceiver component at step 208. In exemplary embodiments, the request includes information relating to the WCD 112 as well as an identifier of the controlled access location. Various identification codes are typically assigned to a wireless device (e.g., electronic serial numbers, mobile identification numbers, and system identification codes), one or more of which may be used by the sound control system to identify the device. The controlled access location identifier may be assigned by the host system 102 or the sound control system application 103 for differentiating each of the controlled access locations it services.

Once the information from step 208 is received, the host system 102 searches a database in storage device 104 for the controlled access location ID. A sample database table 400 is shown in FIG. 4. The database table 400 of FIG. 4 identifies which control access locations are authorized to change the state of a wireless communication device. As described above, the authorizations may stem from laws designed to protect safety or may be implicit/explicit permissions granted by the user of the wireless communication device. The database table 400 of FIG. 4 provides information for facilitating the authorization process. Database table 400 includes a location ID column 402 that stores identifiers for each controlled access location serviced by host system 102.

CA Code column 404 provides levels of authorization granted to a controlled access location. For example, CA Code AA may be a high priority authorization granted, e.g., as a result of laws passed, where safety concerns are known to exist (e.g., airline flights, hospitals, etc.). CA Code AB may provide a lower level of authorization, e.g., where a per-event authorization requirement is desired. This may be a situation in which a controlled access location requires sound control services on a periodic basis rather than on a daily basis due to the nature of activities or events occurring at the location. CA Code CC may provide the lowest level of authorization, e.g., a controlled access location is authorized to alter the state of a communications device only when the user permits such alteration. It will be understood and appreciated by those skilled in the art that other levels or bases of authorization may be utilized in implementing the sound control activities. For example, a CA Code level may specify that under certain conditions, a volume-lowering alteration may be implemented but never an alteration resulting in a transfer to silent mode.

Host system 102 determines whether a device within the controlled access location 106 is authorized to change the state of the wireless communication device 112 based upon the data provided in the database table 400 at step 210. If not, the request is denied at step 212. Otherwise, a signal is sent to the wireless communication device 112 in order to change the state at step 214. The signal may be transmitted directly via the transceiver component of sound control system 114A or alternatively, if the host system 102 is the service provider (e.g., carrier) of the wireless communication device 112, then the host system 102 may send the signal to the wireless communications device 112 at step 216. If the host system 102 is a third-party application service provider, then a request to send the signal may be transmitted to the appropriate carrier of the wireless communications device 112, which in turn, signals the wireless communications device 112.

Returning now to step 204, if it is determined that the movement is not an ingress (i.e., the communication device is leaving the controlled access location 106), or alternatively, if the control point is exit only, the sound control system 114A (or 114B) determines the device ID at step 218 as described above in step 206 and sends a signal to the wireless communication device 112 in order to reset the sound control setting on the wireless communication device 112 to its original state at step 220. This step may include storing the original state of the sound control setting (upon entrance to the controlled access location 106) in memory internal to sound control system 114A or 114B and retrieving the original state information for resetting the sound control settings.

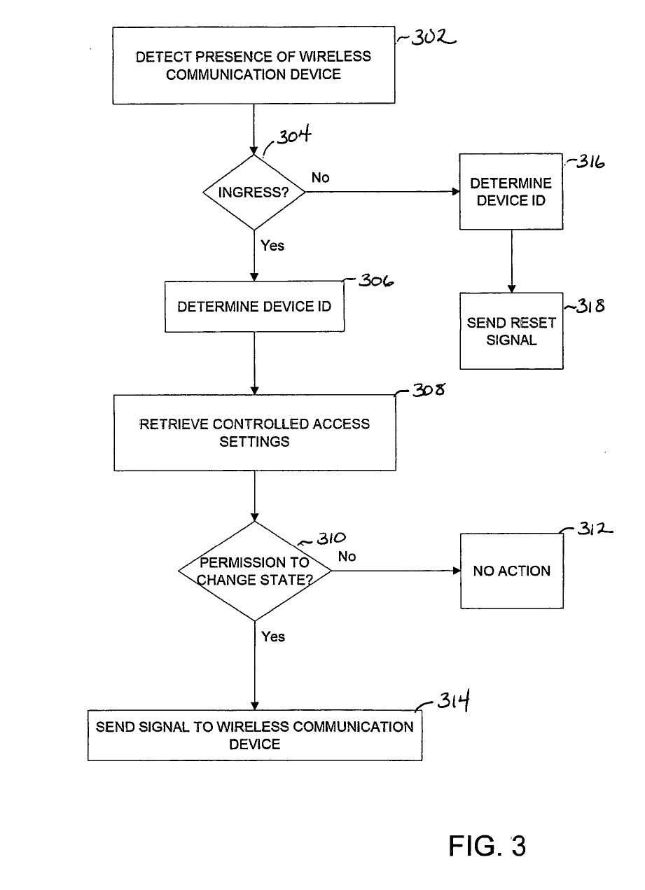

As indicated above, there may be situations in which no authorization is needed before changing a state on a communication device. Turning now to FIG. 3, a flow diagram of a process for implementing the sound control activities without authorization will now be described. A user with a wireless communications device 112 approaches a controlled access location 106. The user then passes through control point 116 and a receiving component of the sound control system 114A detects its presence at step 302.

As the control points are bi-directional (e.g., persons may both enter and exit via either of the control points), it is determined whether the presence of the wireless communication device 112 is related to an ingress or egress at step 304. If the movement is ingress (i.e., the communication device is entering the controlled access location 106), the sound control system application 103 identifies the wireless communication device 112 at step 306. The sound control system 114A or 114B then retrieves the controlled access settings for the wireless communications device 112 at step 308. The settings may be stored directly on the wireless communications device in its internal memory or may be stored in a record that is managed by host system 102 in storage device 104. Regardless of the storage location, the sound control system 114A acquires the information via its transceiver component in a manner similar to that described above in step 208 of FIG. 2. Sample access control settings may include the following information.
ACCESS CTRL SETTING
VIBRATE_Y/N
SILENT_Y/N
LOWER_VOL_Y/N

Accordingly, a user may select which sound control setting should be used in any controlled access location (where no laws pre-empt such permissions). Additionally, access control settings may be stored in a database on storage device 104, a sample of which is shown in FIG. 5. Database 500 provides a customer ID column 502 which may refer to the account number associated with a customer or a serial number assigned to the wireless communication device. A permissions column 504 provides a permissions structure that may be established by a customer, by law, or a combination of both. For example, permissions setting AA 1 may refer to a high level setting that is automatically set by law and is un-editable by the host system and the customer, whereby the number ‘1’ indicates that the item is set. AB 1 may refer to a moderate level setting that is editable by a customer (e.g., permission granted to automatically adjust state in level AB location). A Service Provider column 506 may be provided for identifying the carrier that services the customer.

It is determined whether a device within the controlled access location 106 is authorized to change the state of the wireless communication device 112 based upon the data provided in the database table 500 at step 310. If not, no action is taken at step 312 (i.e., the device's state is not changed). Otherwise, a signal is sent to the wireless communication device 112 in order to change the state at step 314. The signal may be transmitted directly via the transceiver component of sound control system 114A or alternatively, if the host system 102 is the service provider (e.g., carrier) of the wireless communication device 112, then the host system 102 may send the signal to the wireless communications device 112. If the host system 102 is a third-party application service provider, then a request to send the signal may be transmitted to the appropriate carrier of the wireless communications device 112, which in turn, signals the wireless communications device 112.

Returning now to step 304, if it is determined that the movement is not an ingress (i.e., the communication device is leaving the controlled access location 106), or alternatively, if the control point is exit only, the sound control system 114A (or 114B) determines the device ID at step 316 as described above in step 306 and sends a signal to the wireless communication device 112 in order to reset the sound control setting on the wireless communication device 112 to its original state at step 318. This step may include storing the original state of the sound control setting (upon entrance to the controlled access location 106) in memory internal to sound control system 114A or 114B and retrieving the original state information for resetting the sound control settings.

As indicated above, the sound control system services provides the ability for controlled access locations to minimize the occurrence of potentially objectionable sound emissions originating from wireless communication devices that are present at these locations. Users of wireless communications devices (e.g., cell phones, pagers, etc.) that frequent a controlled access location may provide explicit or implicit permission for their devices to be manipulated at a point of entry to, and exit from, the controlled access location. The controlled access services include manipulating these devices by sending one or more signals to the devices causing their sound control states or settings to be altered. These alterations include setting a ringer function to vibrate or silent mode (e.g., an LED may flash indicating an incoming call), or a volume-lowering function that sets the volume to a pre-established level.

As described above, embodiments may be in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

What is claimed is:

1. A method for implementing proximity-based sound emission controls, comprising:
detecting the presence of a device at a controlled access location, the detecting performed upon entrance to the controlled access location by the device; and
adjusting sound control settings established for the device responsive to the detection of the presence of the device at the controlled access location.

2. The method of claim 1, further comprising:
resetting the sound control settings upon exiting the controlled access location by the device.

3. The method of claim 1, wherein detecting the presence of a device includes receiving a signal emitted from the device.

4. The method of claim 1, further comprising:
requesting authorization to adjust the sound control settings.

5. The method of claim 4, further comprising providing authorization to adjust the sound control settings based on at least one of:
an enacted law;
a permission granted by a user of the device; and
a service provider.

6. The method of claim 4, further comprising determining an identifier of the device and contacting a service provider associated with the device via the identifier, wherein the requesting authorization is directed to the service provider.

7. The method of claim 4, further comprising determining an identifier of the device and contacting the device via the identifier, wherein the requesting authorization is directed to the device.

8. The method of claim 1, wherein the device comprises at least one of:
a cellular telephone;
a pager; and
a personal digital assistant; and
wherein further the sound control settings include at least one of:
a vibrate mode;
a silent mode including a light emitting diode; and
a volume-lowering adjustment mode.

9. A device for implementing proximity-based sound emission controls, comprising:
a receiver component for detecting the presence of the communications device at a controlled access location, the detecting performed upon entrance to the controlled access location by the communications device; and
an application executing on a processor for adjusting the sound control settings established by the communications device responsive to the detection of the presence of the communications device at the controlled access location.

10. The device of claim 9, wherein the application further performs:
resetting the sound control settings upon exiting the controlled access location by the communications device.

11. The device of claim 9, wherein the detecting the presence of the communications device includes receiving a signal emitted from the communications device.

12. The device of claim 9, wherein the application further performs:
requesting authorization to adjust the sound control settings.

13. The device of claim 12, wherein authorizations are established in response to at least one of:
an enacted law;
a permission granted by a user of the communications device; and
a service provider.

14. The device of claim 12, wherein the application further performs:
determining an identifier of the communications device and contacting a service provider associated with the communications device via the identifier, wherein the requesting authorization is directed to the service provider.

15. The device of claim 12, wherein the application further performs:
determining an identifier of the communications device and contacting the communications device via the identifier, wherein the requesting authorization is directed to the communications device.

16. The device of claim 9, wherein the communications device comprises at least one of:
a cellular telephone;
a pager; and
a personal digital assistant; and
wherein further the sound control settings include at least one of:
a vibrate mode;
a silent mode including a light emitting diode; and
a volume-lowering adjustment mode.

17. A computer program product for implementing proximity-based sound emission controls, the computer program product including instructions for performing:
detecting the presence of a device at a controlled access location, the detecting performed upon entrance to the controlled access location by the device; and
adjusting sound control settings established for the device responsive to the detection of the device at the controlled access location.

18. The computer program product further comprising instructions for performing:
resetting the sound control settings upon exiting the controlled access location by the device.

19. The computer program product of claim 17, further comprising instructions for performing:
requesting authorization to adjust the sound control settings;
determining an identifier of the device; and
performing at least one of:
contacting a service provider associated with the device via the identifier, wherein the requesting authorization is directed to the service provider; and
contacting the device via the identifier, wherein the requesting authorization is directed to the user of the device.

20. The computer program product of claim 17, wherein the device comprises at least one of:
a cellular telephone;
a pager; and
a personal digital assistant; and
wherein further the sound control settings include at least one of:
a vibrate mode;
a silent mode including a light emitting diode; and
a volume-lowering adjustment mode.
